SEQUENCE LISTING (6 sequences)

SEQ ID NO: 1 - protein, 773 aa, Alkalihalobacillus akibai
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 294 aa, Sordaria fimicola
MRSSTILQTGLVAVLPFAVQAASGSGKSTRYWDCCKPSCAWSGKASVNRPVLACDANNNPLNDANVKSGCDGGSAYTCANNSPWAVNDNLAYGFAATKLSGGTESSWCCACYALTFTSGPVSGKTLVVQSTSTGGDLGSNHFDLNMPGGGVGLFDGCKREFGGLPGAQYGGISSRSECDSFPAALKPGCQWRFDWFKNADNPEFTFKQVQCPSELTSRTGCKRNDDSQFPAFTPPSGGGSNPSTPTTPPSSGGGGSGCAAAMYAQCGGSGFSGCTNCPSGSTCKAINDYYHQCA

SEQ ID NO: 3 - protein, 305 aa, Humicola insolens
MRSSPLLRSAVVAALPVLALAADGRSTRYWDCCKPSCGWAKKAPVNQPVFSCNANFQRITDFDAKSGCEPGGVAYSCADQTPWAVNDDFALGFAATSIAGSNEAGWCCACYELTFTSGPVAGKKMVVQSTSTGGDLGSNHFDLNIPGGGVGIFDGCTPQFGGLPGQRYGGISSRNECDRFPDALKPGCYWRFDWFKNADNPSFSFRQVQCPAELVARTGCRRNDDGNFPAVQIPSSSTSSPVNQPTSTSTTSTSTTSSPPVQPTTPSGCTAERWAQCGGNGWSGCTTCVAGSTCTKINDWYHQCL

SEQ ID NO: 4 - protein, 299 aa, Thielavia terrestris
MRSTPVLRTTLAAALPLVASAASGSGQSTRYWDCCKPSCAWPGKAAVSQPVYACDANFQRLSDFNVQSGCNGGSAYSCADQTPWAVNDNLAYGFAATSIAGGSESSWCCACYALTFTSGPVAGKTMVVQSTSTGGDLGSNHFDIAMPGGGVGIFNGCSSQFGGLPGAQYGGISSRDQCDSFPAPLKPGCQWRFDWFQNADNPTFTFQQVQCPAEIVARSGCKRNDDSSFPVFTPPSGGNGGTGTPTSTAPGSGQTSPGGGSGCTSQKWAQCGGIGFSGCTTCVSGTTCQKLNDYYSQCL

SEQ ID NO: 5 - protein, 295 aa, Staphylotrichum coccosporum
ADGKSTRYWDCCKPSCSWPGKASVNQPVFACSANFQRISDPNVKSGCDGGSAYACADQTPWAVNDNFSYGFAATSISGGNEASWCCGCYELTFTSGPVAGKTMVVQSTSTGGDLGTNHFDLAMPGGGVGIFDGCSPQFGGLAGDRYGGVSSRSQCDSFPAALKPGCYWRFDWFKNADNPTFTFRQVQCPSELVARTGCRRNDDGNFPVFTPPSGGQSSSSSSSSSAKPTSTSTSTTSTKATSTTSTASSQTSSSTGGGCAAQRWAQCGGIGFSGCTTCVSGTTCNKQNDWYSQCL

SEQ ID NO: 6 - protein, 214 aa, Melanocarpus albomyces
ANGQSTRYWDCCKPSCGWRGKGPVNQPVYSCDANFQRIHDFDAVSGCEGGPAFSCADHSPWAINDNLSYGFAATALSGQTEESWCCACYALTFTSGPVAGKTMVVQSTSTGGDLGSNHFDLNIPGGGVGLFDGCTPQFGGLPGARYGGISSRQECDSFPEPLKPGCQWRFDWFQNADNPSFTFERVQCPEELVARTGCRRHDDGGFAVFKAPSA

(19) United States
(12) Patent Application Publication
(10) Pub. No.: US 2024/0376409 A1
(43) Pub. Date: Nov. 14, 2024

(54) FRAGRANCE BEAD COMPOSITION AND USE THEREOF

(71) Applicant: Novozymes A/S, Bagsvaerd (DK)

(72) Inventors: Wenwen Tao, Beijing (CN); Zezhen Zhang, Beijing (CN); Cheng Zhang, Beijing (CN); Jiarui Huang, Beijing (CN)

(73) Assignee: Novozymes A/S, Bagsvaerd (DK)

(21) Appl. No.: 18/685,684

(22) PCT Filed: Aug. 23, 2022
(86) PCT No.: PCT/CN2022/114120

§ 371 Date: Feb. 22, 2024

(30) Foreign Application Priority Data
Aug. 23, 2021 (WO) PCT/CN2021/113990

(51) Int. Cl. C11D 3/386; C11D 3/50; D06M 16/00

(52) U.S. Cl. CPC C11D 3/38645; C11D 3/50; D06M 16/003; C11D 2111/12

(57) ABSTRACT

Provided is a fragrance bead composition comprising an enzyme having cellulase activity and one or more fragrance compounds, as well as the use thereof.

### REFERENCE TO A SEQUENCE LISTING

This application contains a sequence listing in computer readable form, which is incorporated herein by reference.

### FIELD OF THE INVENTION

The invention is generally concerned with use of an enzyme having cellulase activity for increasing deposition of a fragrance compound to a textile, a fragrance bead composition comprising said enzyme, and a method for increasing deposition of a fragrance compound to a textile as well as a method for preparing a fragrance bead composition or a laundry detergent composition with reduced fragrance content while maintaining fragrance deposition to a textile after wash.

### BACKGROUND OF THE INVENTION

Fragrance compounds such as essential oils are often added to detergents and scent boosters e.g. fragrance beads to provide consumers with a magical fragrance experience during different stages of the laundry process. Fragrance deposition and longevity on textiles from detergent compositions or fragrance bead compositions are important to provide an olfactory aesthetic benefit and to serve as a signal that fabrics are clean. Consumers increasingly demand impactful and long-lasting fragrance on their laundry, even weeks after washing. Continuous efforts are made for improvements. Generally, these improvements center around controlling the rate of release of the perfume and the proper selection of the perfume components.

On the other hand, the use of fragrance or perfume in laundry process has faced several challenges. For example, many fragrance components are released very quickly, thus the effect of perfume often does not last very long. In addition, with the increasing awareness of perfume allergy, there is a trend to use detergents or fragrance beads containing less perfume. Furthermore, perfume is expensive and can represent a significant factor in the overall cost of e.g., fragrance beads.

There is a need to optimize the design of fragrance bead or detergent products to improve deposition of fragrance onto textiles in order to improve fragrance impact on textiles, and to minimize wastage of fragrance discarded in the wash liquor, as well as to reduce fragrance amount in these products while still maintaining similar level of perfume effect.

### SUMMARY OF THE INVENTION

The present invention generally relates to use of an enzyme having cellulase activity for increasing deposition of a fragrance compound to a textile.

In one aspect, the present invention relates to use of an enzyme having cellulase activity in a laundering process in the presence of one or more fragrance compounds for increasing deposition of a fragrance compound to a textile.

In another aspect, the present invention relates to use of an enzyme having cellulase activity in a fragrance bead composition or in a laundry detergent composition for increasing deposition of a fragrance compound to a textile, wherein the fragrance bead composition or the cleaning composition comprises one or more fragrance compounds.

In a further aspect, the present invention relates to a fragrance bead composition comprising an enzyme having cellulase activity and one or more fragrance compounds, as well as use of the fragrance bead composition for increasing deposition of a fragrance compound to a textile.

In a further aspect, the present invention relates to use of a laundry detergent composition for increasing deposition of a fragrance compound to a textile, wherein the laundry detergent composition comprises an enzyme having cellulase activity and one or more fragrance compounds.

In a further aspect, the present invention relates to a method for increasing deposition of a fragrance compound to a textile, comprising:
(a) exposing the textile to a wash liquor comprising an enzyme having cellulase activity and one or more fragrance compounds, or to a wash liquor comprising the fragrance bead composition as described above; and
(b) optionally rinse the textile.

In a further aspect, the present invention relates to a method for preparing a fragrance bead composition or a laundry detergent composition with reduced fragrance content while maintaining fragrance deposition to a textile after wash, wherein the method comprises adding an enzyme having cellulase activity to said composition.

### Overview of Sequences

SEQ ID NO:1 is an enzyme having cellulase activity from Alkalihalobacillus akibai.

SEQ ID NO:2 is an enzyme having cellulase activity from Sordaria fimicola

SEQ ID NO:3 is an enzyme having cellulase activity from Humicola insolens

SEQ ID NO:4 is an enzyme having cellulase activity from Thielavia terrestris.

SEQ ID NO:5 is an enzyme having cellulase activity from Staphylotrichum cocosporum.

SEQ ID NO:6 is an enzyme having cellulase activity from Melanocapus albomyces.

### Definitions

As used herein, the singular forms “a”, “an”, and “the” are intended to include the plural forms as well, unless the context clearly indicates otherwise.

If not indicated otherwise, all references to percentages in relation to the disclosed compositions relate to wt % relative to the total weight of the respective composition.

Cellulase: The term “cellulolytic enzyme” or “cellulase” or “enzyme having cellulase activity” means one or more (e.g., several) enzymes that catalyze the decomposition of cellulosic material by hydrolysis of beta-1,4-glycosidic bonds. Such enzymes include endoglucanase(s), cellobiohydrolase(s), beta-glucosidase(s), or combinations thereof. The two basic approaches for measuring cellulolytic activity include: (1) measuring the total cellulolytic activity, and (2) measuring the individual cellulolytic activities (endoglucanases, cellobiohydrolases, and beta-glucosidases) as reviewed in Zhang et al., Outlook for cellulase improvement: Screening and selection strategies, 2006, Biotechnology Advances 24:452-481. Total cellulolytic activity is usually measured using insoluble substrates, including Whatman No 1 filter paper, microcrystalline cellulose, bacterial cellulose, algal cellulose, cotton, pretreated lignocellulose, etc. The most common total cellulolytic activity assay is the filter paper assay using Whatman No 1 filter paper as the substrate. The assay was established by the International Union of Pure and Applied Chemistry (IUPAC) (Ghose, 1987, Measurement of cellulase activities, Pure Appl. Chem. 59:257-68).

For purposes of the present invention, cellulolytic enzyme activity may be determined by the method described in Assay I of the present invention. However, any other method known in the art may also be used to determine the cellulase activity.

Family GH45 cellulase: the term “family GH45 cellulase” as used herein, refers to Glycosyl hydrolases that catalyze the hydrolysis of the glycosyl bond. There are over 100 classes of Glycosyl hydrolases which have been classified, see Henrissat et al. (1991), A classification of glycosyl hydrolases based on amino-acid sequence similarities, J. Biochem. 280:309-316 and the CAZY website at www.cazy.org. The glycoside hydrolases of family 45 (GH45) have so far been identified as endoglucanase (EC 3.2.1.4). Within the definition falls enzymes which are commonly known as “cellulases”. Such enzymes comprise also enzymes that may be known as endoglucanases.

Fragment: The term “fragment” as used in the context of a polypeptide means a polypeptide having one or more amino acids absent from its amino and/or carboxyl terminus, wherein the fragment has enzyme activity. The fragment may be produced naturally during expression and/or purification of the polypeptide, or may be the result of expression of a modified nucleotide sequence expressing the fragment or of targeted removal of amino acids from the amino and/or carboxy terminus. In one aspect, a fragment contains at least 85%, e.g., at least 90%, at least 95%, at least 96%, at least 97% or at least 98% of the amino acid residues of the mature polypeptide of an enzyme.

Sequence identity: The relatedness between two amino acid sequences or between two nucleotide sequences is described by the parameter “sequence identity”.

For purposes of the present invention, the sequence identity between two amino acid sequences is determined as the output of “longest identity” using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 6.6.0 or later. The parameters used are a gap open penalty of 10, a gap extension penalty of 0.5, and the EBLOSUM62 (EMBOSS version of BLOSUM62) substitution matrix. In order for the Needle program to report the longest identity, the nobrief option must be specified in the command line. The output of Needle labeled “longest identity” is calculated as follows:

(Identical Residues×100)/(Length of Alignment−Total Number of Gaps in Alignment)

Variant: The term “variant” means a polypeptide having enzyme activity comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position.

Mature polypeptide: The term “mature polypeptide” means a polypeptide in its final form following translation and any post-translational modifications, such as N-terminal processing, C-terminal truncation, glycosylation, phosphorylation, etc. It is known in the art that a host cell may produce a mixture of two of more different mature polypeptides (i.e., with a different C-terminal and/or N-terminal amino acid) expressed by the same polynucleotide. It is also known in the art that different host cells process polypeptides differently, and thus, one host cell expressing a polynucleotide may produce a different mature polypeptide (e.g., having a different C-terminal and/or N-terminal amino acid) as compared to another host cell expressing the same polynucleotide. In one embodiment, the mature polypeptide is amino acids 22 to 294 of SEQ ID NO: 2, and amino acids 1 to 21 of SEQ ID NO:2 are a signal peptide. In another embodiment, the mature polypeptide is amino acids 22 to 305 of SEQ ID NO: 3, and amino acids 1 to 21 of SEQ ID NO:3 are a signal peptide. In yet another embodiment, the mature polypeptide is amino acids 22 to 299 of SEQ ID NO: 4, and amino acids 1 to 21 of SEQ ID NO:4 are a signal peptide.

Textile: The term “textile” as it is used herein refers to any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be blends or mixtures of cellulose based and non-cellulose based fibers. Examples of blends are mixtures of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric or textile may be conventional washable laundry, for example stained household laundry. When the term fabric or garment is used it is intended to include the broader term textiles as well.

The textile contemplated in the present invention may be any pure form, such as 100% cotton, 100% polyester or the like, or it may be any blend or mixture of different types of textile, such as a mixture of at least 30% polyester and at least 50% cotton, e.g., 50% cotton and 50% polyester. Thus, in one embodiment, the textile is 100% cotton. In another embodiment, the textile is a mixture of at least 50% polyester and at least 20% cotton.

The textile may have been pre-washed (treated) in a laundering process. The laundering process may be done at various temperatures depending on the textile, the level of dirt on the textile, or any other aspect that may be dependent on the temperature. The invention is not limited to any specific temperature. Thus, in one embodiment, the pre-washing has been done at a temperature of at least 5° C., such as at least 10° C., at least 15° C., at least 20° C., at least 25° C., at least 30° C., at least 35° C., at least 40° C., at least 45° C., or at least 50° C., or at least 60° C.

Fragrance bead: A fragrance bead (may be also referred to as “perfume bead” or “aroma bead”) is a type of scent boosters which are applied to textiles during the laundering process, e.g., in the wash cycle, or preferably in a rinse cycle/process, to impart a long-lasting fragrance impression to textiles particularly after wash or during dry stages such as storage, ironing or wearing of clothing. Fragrance beads typically comprise one or more (e.g., 4, 5, 6 or even more than 8) different fragrance compounds, such as Methyl-beta-ionone, α-Pinene, hexyl acetate, 2-tert-Butylcyclohexyl acetate, D-Limonene, 2-Methyl-3-(p-isopropylphenyl) propionaldehyde, terpinolene and octanal or the like, and perfume dispersant materials such as polyethylene glycol. A fragrance bead is typically presented in a colored tablet format. Popular fragrance bead products on the market are e.g. Downy scent beads produced by P&G, and Comfort scent beads produced by Unilever.

Cleaning component: The term “cleaning component” (or “detergent ingredient”) means a detergent adjunct ingredient that typically includes, but are not limited to the components described below, such as surfactants, builders and co-builders, flocculating aid, chelating agents, dye transfer inhibitors, enzyme stabilizers, enzyme inhibitors, catalytic materials, bleach activators, hydrogen peroxide, sources of hydrogen peroxide, preformed peracids, polymeric agents, clay soil removal/anti-redeposition agents, brighteners, suds suppressors, dyes, perfumes, structure elasticizing agents, fabric softeners, carriers, hydrotropes, fabric hueing agents, anti-foaming agents, dispersants, processing aids, and/or pigments. Detergent compositions will typically contain at least one surfactant along with additional components such as at least one builder and/or at least one bleach component.

Detergent composition: The term “detergent composition” or “cleaning composition” refers to compositions that find use in the removal of undesired compounds from items to be cleaned, such as textiles. The detergent composition may be used to e.g. clean textiles for both household cleaning and industrial cleaning. The term encompasses any materials/compounds selected for the particular type of detergent composition desired and the form of the product (e.g., liquid, gel, powder, granulate, paste, or spray compositions) and includes, but is not limited to, detergent compositions such as liquid and/or solid laundry detergents and fine fabric detergents; fabric fresheners; and textile and laundry pre-spotters/pretreatment. In addition to containing the enzyme having cellulase activity of the present invention, the detergent formulation may contain one or more additional detergent enzymes (such as proteases, amylases, lipases, cutinases, xyloglucanases, pectinases, pectin lyases, xanthanases, peroxidases, haloperoxygenases, catalases, mannanases, nucleases or any mixture thereof), and/or detergent adjunct ingredients such as surfactants, builders, chelators or chelating agents, bleach system or bleach components, polymers, fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, transferases, hydrolytic enzymes, oxido reductases, bluing agents and fluorescent dyes, antioxidants, and solubilizers.

Laundering process: The term “laundering process” relates to both household laundering and industrial laundering and means the process of treating textiles with a solution containing a cleaning component or a cleaning composition e.g. a laundry detergent composition and optionally other products such as a fragrance bead composition. The laundering process can for example be carried out using e.g. a household or an industrial washing machine or can be carried out by hand. In the present invention, the laundering process may comprise wash cycle/process and rinse cycle/process.

Wash cycle: The term “wash cycle” is defined herein as a washing operation wherein textile is exposed to the wash liquor for a period of time by circulating the wash liquor and textile in e.g. a washing machine. A wash cycle may be repeated one, two, three, or even four times at the same or at different temperatures. The wash cycle is often followed by a rinse cycle and finally a centrifugation cycle where water is removed from the textile. It is known for the skilled person to determine which is the wash cycle during laundry wash.

Wash liquor: The term “wash liquor” is intended to mean the solution or mixture of water and other detergent ingredients such as surfactants and optionally including enzymes or scent boosters (e.g. fragrance beads) that may be used in the wash cycle.

Rinse cycle: The term “rinse cycle” is defined herein as a rinsing operation wherein textile is exposed to water for a period of time by circulating the water and optionally mechanically treat the textile in order to rinse the textile and finally the superfluous water is removed. A rinse cycle is normally shorter duration compared a wash cycle and may be repeated one, two, three, four, five or even six times at the same or at different temperatures.

Perfume effect: The term “perfume effect” (or “fragrance effect”) in the context of the present invention is related to the human perception of fragrance on washed textiles. The perfume effect of an enzyme having cellulase activity can be analyzed e.g. by means of a sensory evaluation such as that described in Example 2. The perfume effect can alternatively be measured by GC-MS analysis and expressed quantitatively as a “fragrance intensity” e.g. as described in Examples 1. An increased perfume effect can thus be expressed as an increased fragrance intensity, such that washing an item with an enzyme having cellulase activity according to the present invention results in an increase in fragrance intensity compared to washing the item under the same conditions but without the enzyme having cellulase activity.

### DETAILED DESCRIPTION OF THE INVENTION

The inventors of the present invention have surprisingly found that enzymes having cellulase activity act synergistically with fragrance compounds, resulting in an enhanced deposition of such compounds onto textiles washed with a fragrance bead composition comprising said enzyme and one or more perfume compounds. As a result of the increased deposition of a fragrance compound on the textiles, an enhanced perfume effect is obtained, allowing the amount of fragrance in such fragrance bead composition to be reduced while still maintaining the desired perfume effect.

Fragrance compounds are often added to a laundering process through e.g. addition of fragrance bead composition or fragrance-containing detergent composition, to mask malodors (e.g. unpleasant smells from body or spices adhered to textiles) and to provide a fresh and clean scent in the washed items, e.g. textiles. To provide consumers with sufficient perfume effect, typical fragrance bead compositions often contain one or more perfume components in a high content, e.g. 6-20 wt %, such as 8-15 wt %, e.g. 10-12 wt %, based on the total amount of the fragrance bead composition. Such high dosage of fragrances leads to high cost of the fragrance bead composition as well a risk of perfume allergy.

The present invention addresses these challenges by providing fragrance bead compositions or detergent compositions comprising an enzyme having celluase activity that has been found to have synergistic effects with fragrance compounds, and which can thereby reduce the need for perfume addition to said compositions, in particular fragrance bead compositions.

Thus, one embodiment of the invention relates to a fragrance bead composition comprising an enzyme having cellulase activity and one or more fragrance compounds. Preferably, the perfume effect of the textile washed by said fragrance bead composition is improved compared to a comparable fragrance bead composition without said enzyme. This may be assessed e.g. using a sensory evaluation such as that described in Example 2 or quantitatively by GC-MS analysis e.g. as described in Example 1.

Another embodiment of the present invention relates to a fragrance bead composition comprising an enzyme having cellulase activity and one or more fragrance compounds, wherein the amount of the one or more fragrance compounds is reduced compared to a comparable fragrance bead composition without said enzyme. It will be understood that such compositions will have a perfume effect corresponding to or substantially the same as that of a comparable fragrance bead composition without said enzyme. This may allow the amount of fragrance to be reduced to no more than 95%, such as no more than 90%, no more than 85%, or even lower, e.g. no more than 80% or no more than 70%, relative to a comparable composition without the enzyme having cellulase activity.

In a preferred embodiment, the textile suitable for this invention may be a 100% cotton textile, or a mixture of cotton with other types of fabric, such as a mixture of at least 50% polyester and at least 20% cotton, or a mixture of at least 30% polyester and at least 40% cotton, such as a polycotton textile made of 60% cotton and 40% polyester. In a specific embodiment, said textile is a wet textile.

In another embodiment of the invention, the fragrance bead composition further comprises, in addition to the enzyme having cellulase activity, one or more additional enzymes such as a protease and/or a DNase as described in the following “additional enzymes” section.

The dosage of the fragrance bead composition may be in a range of 0.5-2 g/L water or wash liquor, e.g. 0.6-1.5 g/L water or wash liquor, to ensure a satisfying perfume effect. In one embodiment, the dosage of the fragrance bead composition is 0.8 g/L wash liquor. In another embodiment, the dosage of the fragrance bead composition is 1.0 g/L wash liquor.

The fragrance bead composition of the present invention can be prepared by any known method in the art, such as those described in WO 2011/056938A1 (P&G Company) and CN112522039A (Liby Co Ltd).

### Enzyme Having Cellulase Activity

The use of enzymes having cellulase activity in surface-treatment compositions is commonly known in the art. By way of example, certain cellulase enzymes have been employed to remove fuzz and pills from fabric surfaces. And further still, in WO 2019/057758 the use of cellulases has been proposed to promote water-absorbency on fabrics treated with cationic surfactants. However, it has not been previously reported the use of cellulase enzymes together with e.g. fragrance beads to promote the deposition of fragrance compounds, which are generally lipophilic materials, onto a textile.

Enzymes having cellulase activity useful in exercise of the present invention may be selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), preferably family GH45 cellulases. It has not previously been shown that using a cellulase, such as a family GH45 cellulase, in fragrance bead compositions can improve deposition of fragrance to a textile. As can be seen in the examples of the present invention, deposition of fragrance to a textile is improved when a cellulase is included into the laundering process together with fragrance beads.

Suitable family GH44 cellulases can be a family 44 xyloglucanase having a sequence of at least 60% identity to positions 40-559 of SEQ ID NO: 2 of WO 2001/062903.

In one embodiment, the enzyme having cellulase activity is a polypeptide having at least 60% sequence identity to the polypeptide of SEQ ID NO: 1, SEQ ID NO: 2, SEQ ID NO: 3, SEQ ID NO: 4, SEQ ID NO: 5 or SEQ ID NO: 6. Preferably the enzyme having cellulase activity is a polypeptide having at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO: 1, SEQ ID NO: 2, SEQ ID NO: 3, SEQ ID NO: 4, SEQ ID NO: 5 or SEQ ID NO: 6, or a fragment thereof having cellulase activity.

In one embodiment, the enzyme having celluase activity is a polypeptide having at least 80%, at least 85%, at least 90%, at least 95%, at least 98%, at least 99% or 100% sequence identity to the mature polypeptide of SEQ ID NO: 1, or a fragment thereof having cellulase activity. In one embodiment, the mature polypeptide is amino acids 1 to 773 of SEQ ID NO: 1. In a specific embodiment, said enzyme is from Alkalihalobacillus, preferably from Alkalihalobacillus akibai.

In another embodiment, the enzyme having celluase activity is a polypeptide having at least 80%, at least 85%, at least 90%, at least 95%, at least 98%, at least 99% or 100% sequence identity to the mature polypeptide of SEQ ID NO: 2, or a fragment thereof having cellulase activity. In one embodiment, the mature polypeptide is amino acids 22 to 294 of SEQ ID NO: 2. In a specific embodiment, said enzyme is from Sordania, preferably from Sordania fimicola.

In another embodiment, the enzyme having celluase activity is a polypeptide having at least 80%, at least 85%, at least 90%, at least 95%, at least 98%, at least 99% or 100% sequence identity to the mature polypeptide of SEQ ID NO: 3, or a fragment thereof having cellulase activity. In another embodiment, the mature polypeptide is amino acids 22 to 305 of SEQ ID NO: 3. In a specific embodiment, said enzyme is from Humicola, preferably from Humicola insolens.

In another embodiment, the enzyme having celluase activity is a polypeptide having at least 80%, at least 85%, at least 90%, at least 95%, at least 98%, at least 99% or 100% sequence identity to the mature polypeptide of SEQ ID NO: 4, or a fragment thereof having cellulase activity. In one embodiment, the mature polypeptide is amino acids 22 to 299 of SEQ ID NO: 4. In a specific embodiment, said enzyme is from Thielavia, preferably from Thielavia terrestris.

In another embodiment, the enzyme having celluase activity is a polypeptide having at least 80%, at least 85%, at least 90%, at least 95%, at least 98%, at least 99% or 100% sequence identity to the mature polypeptide of SEQ ID NO: 5, or a fragment thereof having cellulase activity. In one embodiment, the mature polypeptide is amino acids 1 to 295 of SEQ ID NO: 5. In a specific embodiment, said enzyme is from Staphylotrichum, preferably from Staphylotrichum cocosporum.

In another embodiment, the enzyme having celluase activity is a polypeptide having at least 80%, at least 85%, at least 90%, at least 95%, at least 98%, at least 99% or 100% sequence identity to the mature polypeptide of SEQ ID NO: 6, or a fragment thereof having cellulase activity. In one embodiment, the mature polypeptide is amino acids 1 to 214 of SEQ ID NO: 6. In a specific embodiment, said enzyme is from Melanocapus, preferably from Melanocapus albomyces.

Other suitable cellulase may be an endo-beta-1,4-glucanase enzyme having a sequence of at least 97% identity to the amino acid sequence of position 1 to position 773 of SEQ ID NO:2 of WO 2002/099091.

Further suitable cellulases include those of bacterial or fungal origin. Chemically modified or protein engineered mutants may be included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

Additional suitable cellulases are the alkaline or neutral cellulases having colour care benefits. Examples of such cellulases are cellulases described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307 and WO99/001544.

Commercially available cellulases include Celluzyme, Carezyme, Carezyme Premium, Celluclean, Celluclean Classic, Cellusoft, Whitezyme, Celluclean 4500T and Celluclean 5000L (all registered trademarks of Novozymes A/S), Clazinase and Puradax HA (registered trademarks of Genencor International Inc.), KAC-500 (B) (registered trademark of Kao Corporation), Revitalenz 200 and Revitalenz 2000 (registered trademarks of Danisco/Dupont), and Biotouch FLX1, Biotouch FCL75, Biotouch DCL and Biotouch FCC45 (registered trademarks of AB Enzymes).

The preparation of the enzyme having celluase activity as described herein can e.g. be performed as described in WO 2015/036579 (incorporated herein by reference). The enzyme of the present invention may also be prepared by any method known in the art.

In particular embodiments of the present invention, the amount of cellulase enzyme that is effective in increasing deposition of fragrance on treated, e.g. laundered, textiles is in the range of 0.01 wt % to 3 wt % based on the total weight of the fragrance bead composition, such as in the range of 0.05 wt % to 2 wt %, 0.1 wt % to 1 wt % or 0.2 wt % to 0.5 wt %, based on the total weight of the fragrance bead composition.

In particular embodiments of the present invention, the amount of cellulase enzyme that is effective in increasing deposition of fragrance on treated, e.g. laundered, textiles may be in the range of 0.005 wt % to 2.5 wt % based on the total weight of the detergent composition, such as in the range of 0.01 wt % to 2 wt %, 0.1 wt % to 1.5 wt % or 0.2 wt % to 0.5 wt %, based on the total weight of the detergent composition.

In another embodiment of the present invention, the amount of cellulase that is effective in increasing deposition of fragrance on treated, e.g. laundered, textiles is dosed in the range of 0.001 mg to 100 mg enzyme protein per liter of wash liquor, such as 0.1 mg to 50 mg enzyme protein, 1 mg to 30 mg enzyme protein or 2 mg to 10 mg enzyme protein, per liter of wash liquor.

### Fragrance Compounds

The term “fragrance compound” (or “perfume compound”) refers to a volatile fragrance compound that is suitable for use in a fragrance bead composition. It may also be referred to by similar terms such as a “perfume component” or a “fragrance ingredient”.

The term “fragrance” includes perfume raw materials and compositions, scents and oils, e.g. essential oils. A wide variety of chemicals are known for fragrance (i.e., perfume) uses, including compounds such as aldehydes, ketones and esters. Also naturally occurring plant and animal oils and exudates comprising complex mixtures of various chemical components are known for use as fragrances.

A perfume is a blend of volatile compounds which can bind to receptors in the nose and therefore has a smell or odor, usually a pleasant one. These compounds are also known as odorants or fragrances. Most perfumes possess molar weights of up to approximately 200 g/mol, in some cases up to about 300 g/mol. Larger molecules are not volatile enough to be perceived by the human nose.

Besides volatility, the odor detection threshold of the fragrance compounds is also important for the perfume functions. The odor detection threshold value is defined as the minimal concentration of a substance that can be detected by a human nose. Thus, compounds with a lower detection odor threshold are more easily detected by humans. Although the threshold is subjective and may vary, it mainly depends on three factors, the vapor pressure, water solubility and the water/organic solvent (octanol) partition coefficient, which together account for 77% of variance in threshold values (Rodriguez et al., 2011, Flavour and Fragrance Journal 26:421-428).

Fragrance compounds used in laundry detergents or fragrance beads may be chemical compounds from any of several different classes or essential oils or other natural compounds. The perfumes that may be used in the context of the present invention are not subject to any restrictions. Thus, in particular synthetic or natural odorant substance compounds of the types esters, ethers, aldehydes (fragrance aldehydes, odorant aldehydes), ketones (fragrance ketones, odorant ketones), alcohols, hydrocarbons, acids, carbonic acid esters, aromatic hydrocarbons, aliphatic hydrocarbons, saturated and/or unsaturated hydrocarbons and mixtures of these may be used as fragrance compounds.

Individual perfume compounds, e.g. synthetic products of the ester, ether, aldehyde, ketone, alcohol, and hydrocarbon types, as well as mixtures thereof can be used. It is preferred, however, to use mixtures of different perfume compounds, which together generate an attractive scent note. Such mixtures can also contain natural perfume mixtures such as those accessible from plant sources, e.g. pine, citrus, jasmine, patchouli, rose or ylang-ylang oil.

Suitable perfumes of the ester type include e.g. benzyl acetate, phenoxy ethyl isobutyrate, p-tert-butyl cyclohexyl acetate, linalyl acetate, dimethyl benzyl carbinyl acetate (DMBCA), phenyl ethyl acetate, ethyl methyl phenyl glycinate, allyl cyclohexyl propionate, styrallyl propionate, benzyl salicylate, cyclohexyl salicylate, floramate, melusate and jasmacyclate.

Odorant substance compounds of the hydrocarbon type include e.g. terpenes such as limonene and pinene.

Suitable perfumes of the ether type include e.g. benzyl ethyl ether and ambroxan.

Suitable perfume ketones can include all ketones that can lend a desired scent or a sensation of freshness. Mixtures of different ketones can also be used. For example the ketone can be selected from the group consisting of buccoxime, iso-jasmone, methyl-beta-naphthyl ketone, Moschus indanone, Tonalid/Moschus plus, alpha-damascone, beta-damascone, delta-damascone, isodamascone, damascenone, damarose, methyl dihydro jasmonate, menthone, carvone, campher, fenchone, alpha-ionene, beta-ionone, dihydro-beta-ionone, gamma-methyl ionone, fleuramone, dihydro jasmone, cis-jasmone, iso-E-Super, methyl cedrenyl ketone or methyl cedrylone, acetophenone, methyl acetophenone, para-methoxy acetophenone, benzyl acetone, benzophenone, para-hydroxy-phenyl butanone, celery ketone or livescone, 6-isopropyl decahydro-2-naphtone, dimethyl octenone, frescomenthe, 4-(1-ethoxyvinyl)-3,3,5,5-tetramethyl cyclohexanone, methyl heptenone, 2-(2-(4-methyl-3-cyclohexen-1-yl)-propyl) cyclopentanone, 1-(para-menthen-6 (2)-yl)-1-propanone, 4-(4-hydroxy-3-methoxy phenyl)-2-butanone, 2-acetyl-3,3-dimethyl norbomane, 6,7-dihydro-1,1,2,3,3-pentamethyl-4 (5H)-indanone, 4-damascol, dulcinyl or cassion, gelsone, hexalone, isocyclemone E, methyl cyclocitrone, methyl lavender ketone, orivone, para-tert-butyl cyclohexanone, verdone, delphone, muscone, neobutenone, plicatone, veloutone, 2,4,4,7-tetramethyl-oct-6-en-3-one, tetrameran, hedione and mixtures thereof. Preferred ketones may e.g. be selected from alpha-damascone, delta-damascone, isodamascone, carvone, gamma-methyl ionone, iso-E-super, 2,4,4,7-tetramethyl-oct-6-en-3-one, benzyl acetone, beta-damascone, damascenone, methyl dihydro jasmonate, methyl cedrylone, hedione and mixtures thereof.

Suitable perfume aldehydes can be any aldehydes that produce a desired scent or a sensation of freshness. They may be individual aldehydes or mixtures of aldehydes. Exemplary suitable aldehydes are melonal, triplal, ligustral, adoxal, anis aldehyde, cymal, ethyl vanillin, florhydral, helional, heliotropine, hydroxy citronellal, koavone, laurin aldehyde, lyral, methyl nonyl acetaldehyde, para-tert-bucinal, phenyl acetaldehyde, undecylene aldehyde, vanillin, 2,6,10-trimethyl-9-andecenal, 3-dodecen-1-al, alpha-n-amyl cinnamaldehyde, 4-methoxy benzaldehyde, benzaldehyde, 3-(4-tert-butylphenyl)-propanal, 2-methyl-3-(para-methoxy phenyl propanal), 2-methyl-4-(2,6,6-trimethyl-2(1)-cyclohexen-1-yl)-butanal, 3-phenyl-2-propenal, cis-/trans-3,7-dimethyl-2,6-octadien-1-al, 3,7-dimethyl-6-octen-1-al, [(3,7-dimethyl-6-octenyl)-oxy]-acetaldehyde, 4-isopropyl benzyaldehyde, 1,2,3,4,5,6,7,8-octahydro-8,8-dimethyl-2-naphthaldehyde, 2,4-dimethyl-3-cyclohexen-1-carboxyaldehyde, 2-methyl-3-(isopropyl-phenyl)-propanal, decylaldehyde, 2,6-dimethyl-5-heptenal, 4-(tricyclo-[5.2.10-(2,6)]-decylidene-8)-butanal, octahydro-4,7-methano-1H-indene carboxaldehyde, 3-ethoxy-4-hydroxy benzaldehyde, para-ethyl-alpha-alpha-dimethyl hydro cinnamaldehyde, alpha-methyl-3,4-(methylene dioxy)-hydro cinnamaldehyde, 3,4-methylene dioxy benzaldehyde, alpha-n-hexyl cinnamaldehyde, m-cymene-7-carboxaldehyde, alpha-methyl phenyl acetaldehyde, 7-hydroxy-3,7-dimethyl octanal, undecenal, 2,4,6-trimethyl-3-cyclohexene-1-carboxaldehyde, 4-(3)-(4-methyl-3-pentenyl)-3-cyclohexene carboxaldehyde, 1-dodecanal, 2,4-dimethyl cyclohexene-3-carboxaldehyde, 4-(4-hydroxy-4-methyl pentyl)-3-cyclohexene-1-carboxaldehyde, 7-methoxy-3,7-dimethyl octan-1-al, 2-methyl undecanal, 2-methyl decanal, 1-nonanal, 1-octanal, 2,6,10-trimethyl-5,9-undecadienal, 2-methyl-3-(4-tert-butyl)-propanal, dihydro cinnamaldehyde, 1-methyl-4-(4-methyl-3-pentenyl)-3-cyclohexene-1-carboxaldehyde, 5- or 6-methoxy hexahydro-4,7-methano indane-1 or 2-carboxy aldehyde, 3,7-dimethyl octan-1-al, 1-undecanal, 10-undecen-1-al, 4-hydroxy-3-methoxy benzaldehyde, 1-methyl-3-(4-methyl pentyl)-3-cyclohexene carboxy aldehyde, trans-4-decenal, 2,6-nonadienal, para-tolyl-acetaldehyde, 4-methyl phenyl acetaldehyde, 2-methyl-4-(2,6,6-trimethyl-1-cyclohexen-1-yl)-2-butenal, ortho-methoxy cinnamaldehyde, 3,5,6-trimethyl-3-cyclohexene carboxaldehyde, 3,7-dimethyl-2-methylene-6-octenal, phenoxy acetaldehyde, 5,9-dimethyl-4,8-decadienal, peony aldehyde (6,1-dimethyl-3-oxa-5,9-undecadien-1-al), hexahydro-4,7-methanoindane-1-carboxaldehyde, 2-methyloctanal, alpha-methyl-4-(1-methyl ethyl)-benzene acetaldehyde, 6,6-dimethyl-2-norpinene-2-propion aldehyde, para-methyl phenoxy acetaldehyde, 2-methyl-3-phenyl-2-propen-1-al, 3,5,5-trimethyl hexanal, hexahydro-8,8-dimethyl-2-naphthaldehyde, 3-propyl-bicyclo-[2.2.1]-hept-5-ene-2-carbaldehyde, 9-decenal, 3-methyl-5-phenyl-1-pentanal, 1-para-menthene-q-carboxaldehyde, citral or mixtures thereof, lilial citral, 1-decanal, 2,4-dimethyl-3-cyclohexene-1-carboxaldehyde. Preferred aldehydes may e.g. be selected from cis/trans-3,7-dimethyl-2,6-octadien-1-al, heliotropin, 2,4,6-trimethyl-3-cyclohexene-1-carboxaldehyde, 2,6-nonadienal, alpha-n-amyl cinnamaldehyde, alpha-n-hexyl cinnamaldehyde, para-tert-bucinal, lyral, cymal, methyl nonyl acetaldehyde, trans-2-nonenal, lilial, trans-2-nonenal and mixtures thereof.

Fragrance compounds may also be natural odorant mixtures such as those accessible from plant sources, e.g. pine, citrus, jasmine, patchouli, rose or ylang-ylang oil. Also suitable are muscat, sage oil, chamomile oil, clove oil, mint oil, cinnamon leaf oil, lime blossom oil, juniper berry oil, vetiver oil, olibanum (frankincense) oil, galbanum oil and labdanlum oil as well as orange blossom oil, neroli oil, orange peel oil and sandalwood oil. The perfume compounds may also be essential oils, e.g. angelica root oil, anise oil, arnica blossom oil, basal oil, bay oil, champaca blossom oil, silver fir oil, silver fir cone oil, elemi oil, eucalyptus oil, fennel oil, spruce needle oil, geranium oil, gingergrass oil, guaiac wood oil, gurjun balsam oil, helichrysum oil, ho leaf oil, ginger oil, iris oil, cajeput oil, calmus oil, camphor oil, canaga oil, cardamom oil, cassia oil, copaiva balsam oil, coriander oil, spearmint oil, caraway oil, cumen oil, lavender oil, lemongrass oil, lime oil, mandarin oil, lemon balm oil, musk seed oil, myrrh oil, niaouli oil, origanum oil, palmarosa oil, peru balsam oil, petit grain oil, pepper oil, peppermint oil, pimento oil, rosemary oil, celery oil, spike oil, stemanis oil, turpentine oil, thuja oil, thyme oil, verbena oil, vermouth oil, wintergreen oil, ysop oil, cinnamon oil, citronella oil, lemon oil and cypress oil.

Further information about fragrance ingredients may be obtained from The International Fragrance Association (IFRA), which publishes a list of all fragrance ingredients used in consumer goods (https://ifrafragrance.org/initiatives/transparency/ifra-transparency-list).

In one embodiment a plurality of perfume compounds, e.g. those listed above or on the list maintained by the IFRA, may be included in a fragrance bead composition or a detergent composition of the present invention. The compositions of the invention may therefore e.g. contain three or more, such as four or more, five or more, six or more, seven or more, or even 10 or more different perfume components. In one embodiment of the invention, the fragrance bead composition comprises at least four fragrance compounds including Methyl-beta-ionone, 2-tert-Butylcyclohexyl acetate, D-Limonene, and 2-Methyl-3-(p-isopropylphenyl) propionaldehyde.

Perfume components may be incorporated into fragrance bead compositions or detergent compositions in physical forms and using methods known in the art, e.g. adding the perfume components as liquids, solid particles and/or microcapsules.

### Detergent Composition

With the surprising findings of the present invention that enzymes having cellulase activity can enhance deposition of fragrance compounds onto washed textiles, the amount of fragrance in a detergent composition can be reduced while still maintaining the desired perfume effect.

Therefore, another aspect of the present invention relates to a detergent composition comprising an enzyme having cellulase activity and one or more fragrance compounds, wherein the amount of one or more fragrance compounds is reduced compared to a comparable detergent composition without said enzyme. It will be understood that such compositions will have a perfume effect corresponding to or substantially the same as that of a comparable detergent composition without said enzyme. In one embodiment, the detergent composition is a laundry detergent composition. This may be assessed e.g. using a sensory evaluation such as that described in Example 2 or quantitatively by GC-MS analysis e.g. as described in Example 1.

A typical detergent composition (may also be referred to a comparable detergent composition in the invention) contains one or more perfume components in a total amount (by weight) of 0.01-5%, such as 0. 1-3%, e.g. 0.5-2%, based on the total amount of the detergent composition.

The amount or the content of the one or more fragrance compounds in a typical detergent composition may be thus reduced to no more than 95 wt %, such as no more than 90 wt %, no more than 85 wt %, or even lower, e.g. no more than 80 wt % or no more than 70 wt %, relative to the comparable detergent composition without the enzyme having cellulase activity.

In one embodiment, the detergent composition comprises an enzyme having cellulase activity and one or more fragrance compounds, wherein the amount of the one or more fragrance compounds is reduced to no more 90 wt %, e.g. no more than 85 wt % or 80 wt % as compared to a comparable detergent composition without said enzyme.

There are no limitations on the type of detergent compositions in which perfumes may be incorporated. They may, for example, be included in detergent compositions that are in the form of liquids, gels, powders, granulates, tablets, pods, pouches and soap bars.

The detergent composition of the present invention may further comprise one or more other cleaning components such as surfactants, builders and co-builders, additional enzymes, enzyme stabilizers, enzyme inhibitors, polymeric agents, clay soil removal/anti-redeposition agents, brighteners, fabric softeners, carriers, hydrotropes, fabric hueing agents, anti-foaming agents, and/or pigments. The choice of cleaning components may include, for textile care, the consideration of the type of textile to be cleaned, the type and/or degree of soiling, and the formulation of the detergent product. Although components mentioned below are categorized by general header according to a particular functionality, this is not to be construed as a limitation, as a component may comprise additional functionalities as will be appreciated by the skilled artisan.

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a mixture of one or more nonionic surfactants and one or more anionic surfactants. The surfactant is typically present at a level of from about 3% to 70% by weight, such as about 5 wt % to about 40 wt %, or about 5 wt % to about 30 wt %, or about 10 wt % to about 20 wt %.

The one or more surfactants are chosen based on the desired cleaning application, and may include any conventional surfactants known in the art.

When included therein the detergent will usually contain from about 3% to about 70% by weight of an anionic surfactant, such as from about 5 wt % to about 50 wt %, including from about 5 wt % to about 20 wt %, or from about 15 wt % to about 20 wt %, or from about 20 wt % to about 25 wt % or at least 30 wt %, at least 40 wt % or at least 50 wt % of an anionic surfactant. Non-limiting examples of anionic surfactants include sulfates and sulfonates, in particular, alkylbenzenesulfonates, such as linear alkylbenzenesulfonates (LAS), isomers of LAS, branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), and combinations thereof.

When included therein the detergent will usually contain from about 2% to about 40% by weigh of a cationic surfactant, for example from about 3% to about 30%, in particular from about 5% to about 20%, from about 3% to about 10%, such as from about 3% to about 5%, from about 8% to about 12% or from about 10% to about 12%. Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

When included therein the detergent will usually contain from about 0.2% to about 40% by weight of a nonionic surfactant, for example from about 0.5 wt % to about 30 wt %, in particular from about 1 wt % to about 20 wt %, from about 3 wt % to about 10 wt %, such as from about 3% wt to about 5 wt %, from about 8 wt % to about 12 wt %, or from about 10 wt % to about 12 wt %. Non-limiting examples of nonionic surfactants include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

When included therein the detergent will usually contain from about 0.01% to about 10% by weight of a semipolar surfactant. Non-limiting examples of semipolar surfactants include amine oxides (AO) such as alkyldimethylamineoxide, N-(coco alkyl)-N, N-dimethylamine oxide and N-(tallow-alkyl)-N,N-bis (2-hydroxyethyl)amine oxide, and combinations thereof.

When included therein the detergent will usually contain from about 0.01% to about 10% by weight of a zwitterionic surfactant. Non-limiting examples of zwitterionic surfactants include betaines such as alkyldimethylbetaines, sulfobetaines, and combinations thereof.

One embodiment relates to a detergent composition e.g. a laundry detergent composition comprising an enzyme having celluase activity, one or more fragrance compounds and at least one surfactant, preferably anionic and/or nonionic, wherein the amount of one or more fragrance compounds is reduced to no more 90 wt %, e.g. no more than 85 wt % as compared to a comparable detergent composition without said enzyme, and preferably wherein the composition comprises from from 5 to 45 wt % surfactant, wherein the surfactant preferably is selected from alkylbenzenesulfonates e.g. LAS, alkyl sulfates (AS) and mixtures thereof, preferably the cleaning composition comprises at least 20 wt % alkylbenzenesulfonate surfactant.

### Builders and Co-Builders

The detergent composition may contain about 0-65% by weight, such as about 5% to about 50%, such as about 0.5% to about 20% of a detergent builder or co-builder, or a mixture thereof. The builder and/or co-builder may particularly be a chelating agent that forms water-soluble complexes with Ca and Mg.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Hoechst), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl) inulin (CMI), and combinations thereof.

The detergent composition may also contain 0-50% by weight, such as about 5% to about 30%, of a detergent co-builder. The detergent composition may include a co-builder alone, or in combination with a builder, for example a zeolite builder. Non-limiting examples of co-builders include homopolymers of polyacrylates or copolymers thereof, such as poly(acrylic acid) (PAA) or copoly(acrylic acid/maleic acid) (PAA/PMA). Further non-limiting examples include citrate, chelators such as aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diphosphonic acid (HEDP), ethylenediaminetetra(methylenephosphonic acid) (EDTMPA), diethylenetriaminepentakis-(methylenephosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)-aspartic acid (SMAS), N-(2-sulfoethyl)-aspartic acid (SEAS), N-(2-sulfomethyl)-glutamic acid (SMGL), N-(2-sulfoethyl)-glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N, N-diacetic acid (ANDA), sulfanilic acid-N,N-diacetic acid (SLDA), taurine-N, N-diacetic acid (TUDA) and sulfomethyl-N, N-diacetic acid (SMDA), N-(2-hydroxyethyl)ethylenediamine-N,N′,N″-triacetic acid (HEDTA), diethanolglycine (DEG), diethylenetriamine penta(methylenephosphonic acid) (DTPMP), aminotris(methylenephosphonic acid) (ATMP), and combinations and salts thereof. Further exemplary builders and/or co-builders are described in, e.g., WO 09/102854, U.S. Pat. No. 5,977,053.

### Bleaching Systems

The detergent composition may contain 0-30% by weight, such as about 1% to about 20%, such as about 0.01% to about 10% of a bleaching system. Any bleaching system comprising components known in the art for use in cleaning detergents may be utilized. Suitable bleaching system components include sources of hydrogen peroxide; sources of peracids; and bleach catalysts or boosters.

Suitable sources of hydrogen peroxide are inorganic persalts, including alkali metal salts such as sodium percarbonate and sodium perborates (usually mono- or tetrahydrate), and hydrogen peroxide-urea (1/1).

Suitable preformed peracids include, but are not limited to, peroxycarboxylic acids such as peroxybenzoic acid and its ring-substituted derivatives, peroxy-α-naphthoic acid, peroxyphthalic acid, peroxylauric acid, peroxystearic acid, ε-phthalimidoperoxycaproic acid [phthalimidoperoxyhexanoic acid (PAP)], and o-carboxybenzamidoperoxycaproic acid; aliphatic and aromatic diperoxydicarboxylic acids such as diperoxydodecanedioic acid, diperoxyazelaic acid, diperoxysebacic acid, diperoxybrassylic acid, 2-decyldiperoxybutanedioic acid, and diperoxyphthalic,-isophthalic and -terephthalic acids; perimidic acids; peroxymonosulfuric acid; peroxydisulfuric acid; peroxyphosphoric acid; peroxysilicic acid; and mixtures of said compounds. It is understood that the peracids mentioned may in some cases be best added as suitable salts, such as alkali metal salts (e.g., Oxone®) or alkaline earth-metal salts.

Suitable bleach activators include those belonging to the class of esters, amides, imides, nitriles or anhydrides and, where applicable, salts thereof. Suitable examples are tetraacetylethylenediamine (TAED), sodium 4-[(3,5,5-trimethylhexanoyl)oxy]benzene-1-sulfonate (ISONOBS), sodium 4-(dodecanoyloxy)benzene-1-sulfonate (LOBS), sodium 4-(decanoyloxy)benzene-1-sulfonate, 4-(decanoyloxy)benzoic acid 4-(DOBA), sodium (nonanoyloxy)benzene-1-sulfonate (NOBS), and/or those disclosed in WO98/17767. A particular family of bleach activators of interest was disclosed in EP624154 and particularly preferred in that family is acetyl triethyl citrate (ATC).

### Hydrotropes

The detergent composition may contain 0-10% by weight, for example 0-5% by weight, such as about 0.5 to about 5%, or about 3% to about 5%, of a hydrotrope. Any hydrotrope known in the art for use in detergents may be utilized. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Polymers

The detergent composition may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs. Exemplary polymers include (carboxymethyl) cellulose (CMC), poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and polycarboxylates such as PAA, PAA/PMA, poly-aspartic acid, and lauryl methacrylate/acrylic acid copolymers hydrophobically modified CMC (HM-CMC) and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Suitable examples include PVP-K15, PVP-K30, ChromaBond S-400, ChromaBond S-403E and Chromabond S-100 from Ashland Aqualon, and Sokalan® HP 165, Sokalan® HP 50 (Dispersing agent), Sokalan® HP 53 (Dispersing agent), Sokalan® HP 59 (Dispersing agent), Sokalan® HP 56 (dye transfer inhibitor), Sokalan® HP 66 K (dye transfer inhibitor) from BASF. Further exemplary polymers include sulfonated polycarboxylates, polyethylene oxide and polypropylene oxide (PEO-PPO) and diquaternium ethoxy sulfate. Other exemplary polymers are disclosed in, e.g., WO 2006/130575. Salts of the above-mentioned polymers are also contemplated. Particularly preferred polymer is ethoxylated homopolymer Sokalan® HP 20 from BASF, which helps to prevent redeposition of soil in the wash liquor.

### Additional Enzymes

The detergent composition of the present invention may comprise, in addition to the enzyme having cellulase activity, one or more additional detergent enzymes known in the art such as one or more proteases, amylases, peroxidases, xanthanases, xanthanlyases, lipases, acyl transferases, phospholipases, esterases, laccases, catalases, aryl esterases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases, pectin methylesterases, transglutaminases, licheninases, laminarinases, DNases, and combinations thereof. In general, the properties of the selected enzymes should be compatible with the selected detergent, (i.e., pH-optimum, compatibility with other enzymatic and non-enzymatic ingredients, etc.), and the enzymes should be present in effective amounts. More details about additional detergent enzymes are as described in e.g. WO 2019/057758 which is incorporated herein by reference. Exemplary description of protease and DNase is shown as below.

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M35 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234. Preferred protease variants may, for example, comprise one or more of the mutations selected from the group consisting of: S3T, V4I, S9R, S9E, A15T, S24G, S24R, K27R, N42R, S55P, G59E, G59D, N60D, N60E, V66A, N74D, S85R, A96S, S97G, S97D, S97A, S97SD, S99E, S99D, S99G, S99M, S99N, S99R, S99H, S101A, V1021, V102Y, V102N, S104A, G116V, G116R, H118D, H118N, A120S, S126L, P127Q, S128A, S154D, A156E, G157D, G157P, S158E, Y161A, R164S, Q176E, N179E, S182E, Q185N, A188P, G189E, V193M, N198D, V1991, Q200L, Y203W, S206G, L211Q, L211D, N212D, N212S, M216S, A226V, K229L, Q230H, Q239R, N246K, S253D, N255W, N255D, N255E, L256E, L256D T268A and R269H, wherein position numbers correspond to positions of the Bacillus lentus protease shown in SEQ ID NO: 1 of WO 2016/001449. Protease variants having one or more of these mutations are preferably variants of the Bacillus lentus protease (Savinase®, also known as subtilisin 309) shown in SEQ ID NO: 1 of WO 2016/001449 or of the Bacillus amyloliquefaciens protease (BPN′) shown in SEQ ID NO: 2 of WO 2016/001449. Such protease variants preferably have at least 80% sequence identity to SEQ ID NO: 1 or to SEQ ID NO: 2 of WO 2016/001449.

Another protease of interest is the alkaline protease from Bacillus lentus DSM 5483, as described for example in WO 91/02792, and variants thereof which are described for example in WO 92/21760, WO 95/23221, EP 1921147, EP 1921148 and WO 2016/096711.

The protease may alternatively be a variant of the TY145 protease having SEQ ID NO: 1 of WO 2004/067737, for example a variant comprising a substitution at one or more positions corresponding to positions 27, 109, 111, 171, 173, 174, 175, 180, 182, 184, 198, 199 and 297 of SEQ ID NO: 1 of WO 2004/067737, wherein said protease variant has a sequence identity of at least 75% but less than 100% to SEQ ID NO: 1 of WO 2004/067737. TY145 variants of interest are described in e.g. WO 2015/014790, WO 2015/014803, WO 2015/014804, WO 2016/097350, WO 2016/097352, WO 2016/097357 and WO 2016/097354.

Examples of preferred proteases include:
(a) variants of SEQ ID NO: 1 of WO 2016/001449 comprising two or more substitutions selected from the group consisting of S9E, N43R, N76D, Q206L, Y209W, S259D and L262E, for example a variant with the substitutions S9E, N43R, N76D, V2051, Q206L, Y209W, S259D, N261W and L262E, or with the substitutions S9E, N43R, N76D, N185E, S188E, Q191N, A194P, Q206L, Y209W, S259D and L262E, wherein position numbers are based on the numbering of SEQ ID NO: 2 of WO 2016/001449;
(b) a variant of the polypeptide of SEQ ID NO: 1 of WO 2016/001449 with the mutation S99SE, wherein position numbers are based on the numbering of SEQ ID NO: 2 of WO 2016/001449;
(c) a variant of the polypeptide of SEQ ID NO: 1 of WO 2016/001449 with the mutation S99AD, wherein position numbers are based on the numbering of SEQ ID NO: 2 of WO 2016/001449;
(d) a variant of the polypeptide of SEQ ID NO: 1 of WO 2016/001449 with the substitutions Y167A+R170S+A194P, wherein position numbers are based on the numbering of SEQ ID NO: 2 of WO 2016/001449;
(e) a variant of the polypeptide of SEQ ID NO: 1 of WO 2016/001449 with the substitutions S9R+A15T+V68A+N218D+Q245R, wherein position numbers are based on the numbering of SEQ ID NO: 2 of WO 2016/001449;
(f) a variant of the polypeptide of SEQ ID NO: 1 of WO 2016/001449 with the substitutions S9R+A15T+G61E+V68A+A194P+V2051+Q245R+N261D, wherein position numbers are based on the numbering of SEQ ID NO: 2 of WO 2016/001449;
(g) a variant of the polypeptide of SEQ ID NO: 1 of WO 2016/001449 with the substitutions S99D+S101R/E+S103A+V104|+G160S; for example a variant of SEQ ID NO: 1 of WO 2016/001449 with the substitutions S3T+V4I+S99D+S101E+S103A+V104I+G160S+V2051, wherein position numbers are based on the numbering of SEQ ID NO: 2 of WO 2016/001449;
(h) a variant of the polypeptide of SEQ ID NO: 2 of WO 2016/001449 with the substitutions S24G+S53G+S78N+S101N+G128A/S+Y217Q, wherein position numbers are based on the numbering of SEQ ID NO: 2 of WO 2016/001449;
(i) the polypeptide disclosed in GENESEQP under accession number BER84782, corresponding to SEQ ID NO: 302 in WO 2017/210295;
(j) a variant of the polypeptide of SEQ ID NO: 1 of WO 2016/001449 with the substitutions S99D+S101E+S103A+V104|+S156D+G160S+L262E, wherein position numbers are based on the numbering of SEQ ID NO: 2 of WO 2016/001449;
(k) a variant of the polypeptide of SEQ ID NO: 1 of WO 2016/001449 with the substitutions S9R+A15T+G61E+V68A+N76D+S99G+N218D+Q245R, wherein position numbers are based on the numbering of SEQ ID NO: 2 of WO 2016/001449;
(l) a variant of the polypeptide of SEQ ID NO: 1 of WO 2016/001449 with the substitutions V68A+S106A, wherein position numbers are based on the numbering of SEQ ID NO: 2 of WO 2016/001449; and
(m) a variant of the polypeptide of SEQ ID NO: 1 of WO 2004/067737 with the substitutions S27K+N109K+S111E+S171E+S173P+G174K+S175P+F180Y+G182A+L184F+Q198E+N199+T297P, wherein position numbers are based on the numbering of SEQ ID NO: 1 of WO 2004/067737.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™, Maxacal™, Maxapem®, Purafect® Ox, Purafect® OxP, Puramax®, FN2™, FN3™, FN4ex™, Excellase®, Excellenz™ P1000, Excellenz™ P1250, Eraser™, Preferenz® P100, Purafect Prime, Preferenz® P110, Preferenz® P300, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), and KAP (Bacillus alkalophilus subtilisin) from Kao.

### DNase

The term “DNase” means a polypeptide having DNase (deoxyribonuclease) activity that catalyzes the hydrolytic cleavage of phosphodiester linkages in a DNA backbone, thus degrading DNA. Preferred DNases may be selected from any of the enzyme classes E.C. 3.1.21.X, where X=1, 2, 3, 4, 5, 6, 7, 8 or 9, e.g. Deoxyribonuclease I, Deoxyribonuclease IV, Type I site-specific deoxyribonuclease, Type II site-specific deoxyribonuclease, Type III site-specific deoxyribonuclease, CC-preferring endo-deoxyribonuclease, Deoxyribonuclease V, T (4) deoxyribonuclease II or T (4) deoxyribonuclease IV, or from E.C. 3.1.22.Y, where Y=1, 2, 4 or 5, e.g. Deoxyribonuclease II, Aspergillus deoxyribonuclease K (1), Crossover junction endo-deoxyribonuclease or Deoxyribonuclease X

DNase polypeptides have been found to be useful for deep cleaning of microbial biofilm that may be present on surfaces such as textiles or dishware or other hard surfaces, and which consists of a matrix of extracellular polymeric substance (EPS) composed of extracellular DNA, proteins, and polysaccharides. When present on textiles, microbial biofilm can result in e.g. malodor and redeposition of soil during laundering.

The DNase polypeptide is typically a microbial enzyme, preferably of fungal or bacterial origin, or a genetically engineered variant of a microbial DNase.

Preferred bacterial DNases include those obtained from Metabacillus indicus (previously known as Bacillus cibi) and variants thereof. Preferred fungal DNases include those obtained from Aspergillus oryzae and variants thereof.

Suitable DNases, DNase variants, and use thereof in detergent compositions are disclosed, for example, in WO 2014/087011, WO 2015/155350 and WO 2019/081721.

### Formulation of Detergent Products

The detergent composition of the present invention may be formulated, for example, as a hand or machine laundry detergent composition including e.g. a laundry additive composition suitable for pre-treatment of stained fabrics. In a specific aspect, the present invention provides a detergent additive comprising one or more enzymes as described herein. The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume.

Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent which is not unit dosed may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may also be non-aqueous.

### Formulation of Enzyme in Granules

Non-dusting granulates may be produced e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono-, di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

The enzymes of the invention may be formulated as a granule, for example as a co-granule that combines one or more enzymes. Each enzyme will then be present in more granules, securing a more uniform distribution of enzymes in the detergent. This also reduces the physical segregation of different enzymes due to different particle sizes. Methods for producing multi-enzyme co-granulates for the detergent industry are disclosed in the IP.com disclosure IPCOM000200739D.

Another example of formulation of enzymes by the use of co-granulates is disclosed in WO 2013/188331, which relates to a detergent composition comprising (a) a multi-enzyme co-granule; (b) less than 10 wt % zeolite (anhydrous basis); and (c) less than 10 wt % phosphate salt (anhydrous basis), wherein said enzyme co-granule comprises from 10 to 98 wt % moisture sink component and the composition additionally comprises from 20 to 80 wt % detergent moisture sink component. WO 2013/188331 also relates to a method of treating and/or cleaning a surface, preferably a fabric surface comprising the steps of (i) contacting said surface with the detergent composition in aqueous wash liquor, (ii) rinsing and/or drying the surface.

A multi-enzyme co-granule may comprise an enzyme of the invention and one or more enzymes selected from the group consisting of proteases, lipases, xyloglucanases, perhydrolases, peroxidases, lipoxygenases, laccases, hemicellulases, xylanases, phospho lipases, esterases, cutinases, pectinases, mannanases, pectate lyases, keratinases, reductases, oxidases, phenoloxidases, ligninases, pullulanases, tannases, pentosanases, lichenases glucanases, arabinosidases, hyaluronidase, chondroitinase, amylases, nucleases, hexosaminidases and mixtures thereof.

An embodiment of the invention relates to an enzyme granule/particle comprising the enzyme of the invention. The granule is composed of a core, and optionally one or more coatings (outer layers) surrounding the core. Typically, the granule/particle size, measured as equivalent spherical diameter (volume based average particle size), of the granule is 20-2000 μm, particularly 50-1500 μm, 100-1500 μm or 250-1200 μm.

The core may include additional materials such as fillers, fibre materials (cellulose or synthetic fibres), stabilizing agents, solubilising agents, suspension agents, viscosity regulating agents, light spheres, plasticizers, salts, lubricants and fragrances.

The core may include binders, such as synthetic polymer, wax, fat, or carbohydrate.

The core may comprise a salt of a multivalent cation, a reducing agent, an antioxidant, a peroxide decomposing catalyst and/or an acidic buffer component, typically as a homogenous blend.

The core may consist of an inert particle with the enzyme absorbed into it, or applied onto the surface, e.g., by fluid bed coating.

The core may have a diameter of 20-2000 μm, particularly 50-1500 μm, 100-1500 μm or 250-1200 μm.

The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation.

Methods for preparing the core can be found in Handbook of Powder Technology; Particle size enlargement by C. E. Capes; Volume 1; 1980; Elsevier.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

The coating may be applied in an amount of at least 0.1% by weight of the core, e.g., at least 0.5%, 1% or 5%. The amount may be at most 100%, 70%, 50%, 40% or 30%.

The coating is preferably at least 0.1 μm thick, particularly at least 0.5 μm, at least 1 μm or at least 5 μm. In a particular embodiment, the thickness of the coating is below 100 μm. In a more particular embodiment the thickness of the coating is below 60 μm. In an even more particular embodiment the total thickness of the coating is below 40 μm.

The coating should encapsulate the core unit by forming a substantially continuous layer. A substantially continuous layer is to be understood as a coating having few or no holes, so that the core unit it is encapsulating/enclosing has few or none uncoated areas. The layer or coating should be homogeneous in thickness.

The coating can further contain other materials as known in the art, e.g., fillers, antisticking agents, pigments, dyes, plasticizers and/or binders, such as titanium dioxide, kaolin, calcium carbonate or talc.

A salt coating may comprise at least 60% by weight w/w of a salt, e.g., at least 65%, at least 70%, at least 75%, at least 80%, at least 85%, at least 90%, at least 95% or at least 99% by weight w/w.

The salt may be added from a salt solution where the salt is completely dissolved or from a salt suspension wherein the fine particles is less than 50 μm, such as less than 10 μm or less than 5 μm.

The salt coating may comprise a single salt or a mixture of two or more salts. The salt may be water soluble, in particular having a solubility at least 0.1 grams in 100 g of water at 20° C., preferably at least 0.5 g per 100 g water, e.g., at least 1 g per 100 g water, e.g., at least 5 g per 100 g water.

The salt may be an inorganic salt, e.g., salts of sulfate, sulfite, phosphate, phosphonate, nitrate, chloride or carbonate or salts of simple organic acids (less than 10 carbon atoms, e.g., 6 or less carbon atoms) such as citrate, malonate or acetate. Examples of cations in these salts are alkali or earth alkali metal ions, the ammonium ion or metal ions of the first transition series, such as sodium, potassium, magnesium, calcium, zinc or aluminium. Examples of anions include chloride, bromide, iodide, sulfate, sulfite, bisulfite, thiosulfate, phosphate, monobasic phosphate, dibasic phosphate, hypophosphite, dihydrogen pyrophosphate, tetraborate, borate, carbonate, bicarbonate, metasilicate, citrate, malate, maleate, malonate, succinate, lactate, formate, acetate, butyrate, propionate, benzoate, tartrate, ascorbate or gluconate. In particular alkali- or earth alkali metal salts of sulfate, sulfite, phosphate, phosphonate, nitrate, chloride or carbonate or salts of simple organic acids such as citrate, malonate or acetate may be used.

The salt in the coating may have a constant humidity at 20° C. above 60%, particularly above 70%, above 80% or above 85%, or it may be another hydrate form of such a salt (e.g., anhydrate). The salt coating may be as described in WO 00/01793 or WO 2006/034710.

Specific examples of suitable salts are NaCl (CH_{20° C.}=76%), Na₂CO₃ (CH_{20° C.}=92%), NaNO₃ (CH_{20° C.}=73%), Na₂HPO₄ (CH_{20° C.}=95%), Na₃PO₄ (CH_{25° C.}=92%), NH₄Cl (CH_{20° C.}.=79.5%), (NH₄)₂HPO₄ (CH_{20° C.}=93.0%), NH₄H₂PO₄ (CH_{20° C.}=93.1%), (NH₄)₂SO₄ (CH_{20° C.}=81.1%), KCl (CH_{20° C.}=85%), K₂HPO₄ (CH_{20° C.}=92%), KH₂PO₄ (CH_{20° C.}=96.5%), KNO₃ (CH_{20° C.}=93.5%), Na₂SO₄ (CH_{20° C.}=93%), K₂SO₄ (CH_{20° C.}=98%), KHSO₄ (CH_{20° C.}=86%), MgSO₄ (CH_{20° C.}=90%), ZnSO₄ (CH_{20° C.}=90%) and sodium citrate (CH_{25° C.}=86%). Other examples include NaH₂PO₄, (NH₄)H₂PO₄, CuSO₄, Mg(NO₃)₂ and magnesium acetate.

The salt may be in anhydrous form, or it may be a hydrated salt, i.e. a crystalline salt hydrate with bound water of crystallization, such as described in WO 99/32595. Specific examples include anhydrous sodium sulfate (Na₂SO₄), anhydrous magnesium sulfate (MgSO₄), magnesium sulfate heptahydrate (MgSO₄·7H₂O), zinc sulfate heptahydrate (ZnSO₄·7H₂O), sodium phosphate dibasic heptahydrate (Na₂HPO₄·7H₂O), magnesium nitrate hexahydrate (Mg(NO₃)₂(6H₂O)), sodium citrate dihydrate and magnesium acetate tetrahydrate. Preferably the salt is applied as a solution of the salt, e.g., using a fluid bed.

Enzyme components may be incorporated into the fragrance bead composition or the detergent composition in any physical forms (e.g. a granule or co-granulate) and using methods known in the art.

Thus, in one embodiment, the fragrance bead composition or the detergent composition of the present invention may comprises a granule comprising:
(a) a core comprising an enzyme according to the invention,
(b) optionally, a coating consisting of one or more layers surrounding the core; and
(c) wherein the granule preferably is a co-granulate comprising one or more additional enzymes, preferably wherein at least one additional enzyme is selected from proteases, amylases and DNase.

### Uses

The present invention is further directed to use of an enzyme having cellulase activity in a laundering process (e.g., in a rinse process) in the presence of one or more fragrance compounds for increasing deposition of a fragrance compound onto a textile.

This aspect further relates to use of an enzyme having cellulase activity in a fragrance bead composition or in a cleaning composition preferably a laundry detergent composition for increasing deposition of a fragrance compound to a textile, wherein the fragrance bead composition or the cleaning composition comprises one or more fragrance compounds.

This aspect of the present invention further relates to use of a fragrance bead composition according to the present invention for increasing deposition of a fragrance compound to a textile.

In one embodiment, the textile is cotton, or a mixture of cotton with other types of fabric, such as a mixture of at least 50% polyester and at least 20% cotton, or a mixture of at least 30% polyester and at least 40% cotton. In a preferred embodiment, the textile is a wet textile.

### Methods

The present invention is further directed to a method for increasing deposition of a fragrance compound to a textile, comprising:
(a) exposing the textile to a wash liquor comprising an enzyme having cellulase activity and one or more fragrance compounds, or to a wash liquor comprising the fragrance bead composition according to the present invention; and
(b) optionally rinsing the textile.

In one embodiment, wherein the textile is cotton, or a mixture of cotton with other types of fabric, such as a mixture of at least 50% polyester and at least 20% cotton, or a mixture of at least 30% polyester and at least 40% cotton.

In one embodiment, the enzyme having cellulase activity is present in an amount of 0.001 mg to 100 mg enzyme protein per liter of wash liquor, such as 0.1 mg to 50 mg enzyme protein, 1 mg to 30 mg enzyme protein or 2 mg to 10 mg enzyme protein, per liter of wash liquor.

The wash liquor may have a temperature in the range of 5° C. to 75° C., or in the range of 10° C. to 70° C., in the range of 20° C. to 60° C., in the range of 25° C. to 50° C., in the range of 30° C. to 40° C. or in the range of 15° C. to 40° C.

Another aspect of the present invention relates to a method for preparing a fragrance bead composition or a laundry detergent composition with reduced fragrance content while maintaining fragrance deposition to a textile after wash, wherein the method comprises including an enzyme having cellulase activity into the fragrance bead composition or the detergent composition.

In one embodiment, the fragrance content in the fragrance bead composition or the laundry detergent composition is reduced to no more than 95%, such as no more than 90%, no more than 85%, or even lower, e.g. no more than 80% or no more than 70%, relative to a comparable composition without the enzyme having cellulase activity.

The invention is further outlined in the following embodiments consecutively numbered starting with embodiment 1 (E1):

E1. Use of an enzyme having cellulase activity in a laundering process (e.g., in a rinse process) in the presence of one or more fragrance compounds for increasing deposition of a fragrance compound to a textile.

E2. Use of an enzyme having cellulase activity in a fragrance bead composition or in a cleaning composition preferably a laundry detergent composition for increasing deposition of a fragrance compound to a textile, wherein the fragrance bead composition or the cleaning composition comprises one or more fragrance compounds.

E3. The use according to embodiment 1 or 2, wherein the textile is cotton, or a mixture of cotton with other types of fabric, such as a mixture of at least 50% polyester and at least 20% cotton, or a mixture of at least 30% polyester and at least 40% cotton, and preferably, the textile is wet textile.

E4. The use according to any of embodiments 1-3, wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

E5. The use according to any of embodiments 1-4, wherein the enzyme having cellulase activity is a polypeptide having at least 60%, at least 65%, at least 70%, at least 75%, at least 80%, at least 85%, at least 90%, at least 95%, at least 96%, at least 97%, at least 98%, at least 99% or 100% sequence identity to any of the mature polypeptide of SEQ ID NO: 1, SEQ ID NO: 2, SEQ ID NO:3, SEQ ID NO:4, SEQ ID NO:5 or SEQ ID NO:6.

E6. The use according to any of embodiments 1-5, wherein the enzyme having cellulase activity is dosed in an amount of 0.01 wt % to 3 wt %, preferably 0.05 wt % to 2 wt %, 0.1 wt % to 1 wt % or 0.2 wt % to 0.5 wt %, based on the total weight of the fragrance bead composition or the total weight of the cleaning composition.

E7. The use according to any of embodiments 1-6, wherein the enzyme having cellulase activity is dosed in an amount of 0.001 mg to 100 mg enzyme protein per liter of wash liquor, such as 0.1 mg to 50 mg enzyme protein, 1 mg to 30 mg enzyme protein or 2 mg to 10 mg enzyme protein, per liter of wash liquor.

E8. The use according to any of embodiments 1-7, wherein the one or more fragrance compounds are selected from a group comprising aldehyde, ketone and/or ester type of fragrances, and the combinations thereof, such as Methyl-beta-ionone, 2-tert-Butylcyclohexyl acetate, D-Limonene, 2-Methyl-3-(p-isopropylphenyl) propionaldehyde, α-Pinene, hexyl acetate, terpinolene and octanal, and combinations thereof.

E9. A fragrance bead composition comprising an enzyme having cellulase activity and one or more fragrance compounds.

E10. The fragrance bead composition according to embodiment 9, wherein the amount of the one or more fragrance compounds is reduced compared to a comparable fragrance bead composition without said enzyme, wherein perfume effect is corresponding to that of the comparable fragrance bead composition without said enzyme.

E11. The composition according to any of embodiments 9 to 10, wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

E12. The composition according to any of embodiments 9 to 11, wherein the enzyme having cellulase activity is a polypeptide having at least 60%, at least 65%, at least 70%, at least 75%, at least 80%, at least 85%, at least 90%, at least 95%, at least 96%, at least 97%, at least 98%, at least 99% or 100% sequence identity to any of the mature polypeptide of SEQ ID NO: 1, SEQ ID NO:2, SEQ ID NO:3, SEQ ID NO:4, SEQ ID NO:5 or SEQ ID NO:6.

E13. The composition according to any of embodiments 9 to 12, wherein the enzyme having cellulase activity is dosed in an amount of 0.01 wt % to 3 wt %, preferably 0.05 wt % to 2 wt %, 0.1 wt % to 1 wt % or 0.2 wt % to 0.5 wt %, based on the total weight of the fragrance bead composition.

E14. The composition according to any of embodiments 9 to 13, wherein the enzyme having cellulase activity is dosed in an amount of 0.001 mg to 100 mg enzyme protein per liter of wash liquor, such as 0.1 mg to 50 mg enzyme protein, 1 mg to 30 mg enzyme protein or 2 mg to 10 mg enzyme protein, per liter of wash liquor.

E15. The composition according to any of embodiments 9 to 14, wherein the one or more fragrance compounds are selected from a group comprising aldehyde, ketone and/or ester type of fragrances, and the combinations thereof, such as Methyl-beta-ionone, 2-tert-Butylcyclohexyl acetate, D-Limonene, 2-Methyl-3-(p-isopropylphenyl) propionaldehyde, α-Pinene, hexyl acetate, terpinolene and octanal, and combinations thereof.

E16. The composition according to any of embodiments 9-15, wherein the amount of the one or more fragrance compounds in the composition is at least 25 wt %, at least 35 wt %, at least 45 wt %, at least 50 wt %, at least 55 wt %, at least 60 wt %, at least 65 wt % or at least 70 wt %, based on the total weight of the composition.

E17. The composition according to any of embodiments 9-16, wherein the composition is capable of increasing deposition of the one or more fragrance compounds to a textile, preferably the textile is cotton, or a mixture of cotton with other types of fabric, such as a mixture of at least 50% polyester and at least 20% cotton, or a mixture of at least 30% polyester and at least 40% cotton.

E18. A cleaning composition comprising an enzyme having cellulase activity as defined in embodiment 4 or 5, one or more fragrance compounds and at least one surfactant, wherein the amount of the one or more fragrance compounds is reduced compared to a comparable cleaning composition without said enzyme, wherein perfume effect is corresponding to that of the comparable cleaning composition without said enzyme.

E19. Use of the fragrance bead composition of any of the embodiments 9-17 for increasing deposition of a fragrance compound to a textile in a laundering process (e.g., in a rinse process).

E20. Use of a laundry detergent composition for increasing deposition of a fragrance compound to a textile, wherein laundry detergent composition comprises an enzyme having cellulase activity and one or more fragrance compounds, wherein the enzyme having cellulase activity is as defined in embodiment 4 or 5.

E21. The use according to embodiment 19 or 20, wherein the textile is cotton, or a mixture of cotton with other types of fabric, such as a mixture of at least 50% polyester and at least 20% cotton, or a mixture of at least 30% polyester and at least 40% cotton, and preferably the textile is wet.

E22. A method for increasing deposition of a fragrance compound to a textile, comprising:
(a) exposing the textile to a wash liquor comprising an enzyme having cellulase activity and one or more fragrance compounds, or to a wash liquor comprising the fragrance bead composition of any of embodiments 9 to 17; and
(b) optionally rinse the textile.

E23. The method according to embodiment 22, wherein the textile is cotton, or a mixture of cotton with other types of fabric, such as a mixture of at least 50% polyester and at least 20% cotton, or a mixture of at least 30% polyester and at least 40% cotton, and preferably the textile is wet.

E24. The method according to embodiment 22 or 23, wherein the enzyme having cellulase activity is as defined in embodiment 4 or 5.

E25. The method according to any of embodiments 22 to 24, wherein the enzyme having cellulase activity is present in an amount of 0.001 mg to 100 mg enzyme protein per liter of wash liquor, such as 0.1 mg to 50 mg enzyme protein, 1 mg to 30 mg enzyme protein or 2 mg to 10 mg enzyme protein, per liter of wash liquor.

E26. The method according to any of embodiments 22 to 25, wherein the one or more fragrance compounds are selected from the group comprising aldehyde, ketone and/or ester type of fragrances, and the combinations thereof, such as Methyl-beta-ionone, 2-tert-Butylcyclohexyl acetate, D-Limonene, 2-Methyl-3-(p-isopropylphenyl) propionaldehyde, α-Pinene, hexyl acetate, terpinolene and octanal, and combinations thereof.

E27. A method for preparing a fragrance bead composition or a laundry detergent composition with reduced fragrance content while maintaining fragrance deposition to a textile after wash, wherein the method comprises adding the enzyme having cellulase activity as defined in embodiment 4 or 5 into the fragrance bead composition or the laundry detergent composition.

E28. The method according to embodiment 27, wherein the fragrance content in the fragrance bead composition or the laundry detergent composition is reduced to no more than 95%, such as no more than 90%, no more than 85%, or even lower, e.g., no more than 80% or no more than 70%, relative to the corresponding comparable composition without the enzyme having cellulase activity.

The invention will be further explained and illustrated with reference to the following non-limiting examples.

### Assays

### Assay I: Testing of Cellulase Activity

Cellulase activity is determined as the ability of an enzyme to catalyze hydrolysis of 1,4-beta-D-glucosidic linkages in beta-1,4-glucan (cellulose). For purposes of the present invention, cellulase activity is determined using AZCL-HE-cellulose (from Megazyme) as the reaction substrate.

### EXAMPLES

### Example 1—GC-MS Detection of Fragrance Compounds Deposition on Textiles Washed with Fragrance Beads+/− Cellulase

Detergent: Model N detergent, Ingredients: 5.3% LAS, 10.7% AEOS, 1% soap, 5.3% non-ionic surfactants, 2% sodium citrate, 0.4% TEA, 0.73% NaOH, 0.02% CaCl₂) add water to 100% (all percentages are w/w).

Fragrance bead: Downy fragrance beads produced by P&G (batch no. 10026146998693), the dosage of Downy fragrance beads is 0.8 g/L wash liquor.

Enzyme: Cellulase with SEQ ID NO:4, available from Novozymes A/S, Bagsværd.

### TOM Wash Test

The Tergo-To-Meter (TOM) is a medium scale model wash system that can be applied to test 16 different wash conditions simultaneously. A TOM is basically a large temperature-controlled water bath with up to 16 open metal beakers submerged into it. Each beaker constitutes one small top loader style washing machine and during an experiment, each of them will contain a solution of a specific detergent/enzyme/polymer system and the soiled and unsoiled fabrics its performance is tested on. Mechanical stress is achieved by a rotating stirring arm, which stirs the liquid within each beaker. In a TOM experiment, factors such as the ballast to soil ratio and the fabric to wash liquor ratio can be varied. Therefore, the TOM provides the link between small scale experiments, and the more time-consuming full-scale experiments.

Set temperature in the TOM and start the rotation in the water bath. Wait for the temperature to adjust (tolerance is +/−0.5° C.). All beakers shall be clean and without traces of prior test material.

The wash solution or the wash liquor with desired amount of detergent (e.g. model N detergent), temperature and water hardness is prepared in a bucket. The detergent is allowed to dissolve during magnet stirring for 10 min. Wash solution shall be used within 30 to 60 min after preparation.

1 L wash solution is added into a TOM beaker. The wash solution is agitated at 120 rpm and then additional components such as fragrance beads and enzymes are added to the beaker. The swatches are sprinkled into the beaker. Time measurement starts when the swatches are added to the beaker. The swatches are washed for 20-60 minutes depending on respective experiment conditions, after which agitation is terminated.

The swatches were subsequently transferred from the TOM beaker to a sieve and rinse under running tap water for 3 minutes. The water was gently pressed out of the swatches by hand and the swatches were then placed in a drain basket, waiting for following tests, i.e., for sensory evaluation and GC-MS analysis.

The detailed TOM wash conditions and materials, as well as the subsequent GC-MS conditions are shown in below tables 1-2.

TABLE 1
TOM wash conditions

| Wash | 30° C., 2 g/L detergent (Model N), 15°dH | |
|---|---|---|
| parameters | (Ca2⁺/Mg2⁺ ratio 3:2) | |
| On top | Cellulase enzymes of the invention: 0.05 wt % or 0.4 wt % | |
| additions | relative to the amount of fragrance beads dosed. | |
| | Fragrance beads: 0.8 g/L | |
| Wash liquor | 1 | L/beaker |
| Rotation | 120 | rpm |
| Wash time | 20 | min |

| | |
|---|---|
| Test swatch | CN 42: Cotton interlock double jersey, purchased |
| | from CFT company. 9 pieces of CN-42 |
| | (d = 3.8 cm) textile per beaker. |
| Repetition | 1 cycle wash |

TABLE 2
GC-MS conditions

| | |
|---|---|
| GC-MS | Agilent 7890 GC with split/splitless injector and 5977 |
| equipment | MS with extractor ion source coupled to a Gerstel |
| | MPS2 sampler with HS/SPME, SPME needle heater. |
| Gas | Oven Temperature: Initial 40° C.; hold 2 min; Rate 5° C./min |
| chroma- | until 150° C.; Rate 35° C./min until 240° C.; Hold 3 min. |
| tography | Front SS Inlet He: Mode Split; T^{a} 230° C., Split Ratio 10:1; |
| | Split Flow 15 mL/min. |
| | Column: Agilent DB-Wax. |
| SPME | Incubation Temperature: 60° C. |
| Incubator/ | Incubation Time: 10.00 min. |
| Agitator | Agitator Speed: 250 rpm. |
| | Sample parameters: |
| | Extraction Time: 2.00 min; |
| | Injection Desorption Time: 120 s. |
| | Fiber: Carboxen/Polydimethylsiloxane (CAR/PDMS) |
| Mass | Acquisition Mode: Scan. |
| spectrom- | Solvent Delay (minutes): 4. |
| etry | Scan Parameters: 5 |
| | Start time : 1Low Mass: 35. |
| | High Mass: 350. |
| | Threshold: 100. |
| | MS Source: 230° C. |
| | MS Quad: 150° C. |

Three pieces of washed CN-42 swatch from same beaker were put into one glass vial for GC-MS analysis according to the conditions shown in the above table 2. Three repetitions for each condition were carried out. The value of the relative intensity (RI) of the four fragrance compounds on cotton textile CN-42 washed with or without cellulase was measured. The corresponding average RI value of the three repetitions were calculated and summarized in below table 3.

The percentage of the fragrance increase evaluated by RI (% RI increase) due to the addition of cellulase was calculated as: (average RI value of the condition with celluase-average RI value of the condition without celluase)/average RI value of the condition without celluase×100. The results were summarized in below table 3.

TABLE 3
Relative intensity of fragrance compounds detected from CN-42
cotton textile washed with or without cellulase SEQ ID NO: 4.

| | RI, | RI, 0.05 | RI, 0.4 | % RI | % RI |
|---|---|---|---|---|---|
| | Without | wt % | wt % | increase, 0.05 | increase, 0.4 |
| | cellulase | cellulase | cellulase | wt % celluase | wt % celluase |
| Methyl-beta- | 5846962.5 | 6228372.3 | 7282370.5 | 6.5 | 24.5 |
| ionone | | | | | |
| (CAS No: | | | | | |
| 127-43-5) | | | | | |
| 2-tert- | 656703.8 | 777235.2 | 904621.7 | 18.4 | 37.8 |
| Butylcyclohexyl | | | | | |
| acetate | | | | | |
| (CAS No: | | | | | |
| 88-41-5) | | | | | |
| D-Limonene | 1006359.8 | 1031012.2 | 1211789.1 | 2.4 | 20.4 |
| (CAS No: | | | | | |
| 5989-27-5) | | | | | |
| 2-Methyl-3-(p- | 1262142.8 | 1327120.4 | 1614562.0 | 5.1 | 27.9 |
| isopropylphenyl) | | | | | |
| propionaldehyde | | | | | |
| (CAS No: | | | | | |
| 103-95-7) | | | | | |
| TOTAL | 8772168.9 | 9363740.1 | 11013343.3 | 6.7 | 25.5 |

The results demonstrate that there is a clear increase in RI of textiles washed with cellulase, suggesting a clear improvement of fragrance deposition on textiles as a result of the use of a cellulase enzyme, even at a low dosage of 0.05 wt %.

### Example 2—Sensory Evaluation of the Scent of Textiles Washed with Fragrance Beads+/− Cellulase

Three pieces of washed CN-42 swatches from same beaker were put into a petri-dish plate. The plate was then covered with a petri-dish lid and stayed at room temperature for 10 mins, to allow the scent from the washed textile to accumulate before sniffing.

Each comparison group includes two samples, one from the condition without cellulase enzyme, the other from the wash condition with 0.05 wt % or 0.4 wt % of cellulase SEQ ID NO:4. Eight trained panelists were asked to open the petri-dish plate and smell the scent to perceive the fragrance intensity. Three repetitions were carried out for each comparison group.

Panelists were first asked to rank the scent intensity between samples (from high to low), and then give a relative score for each sample: i.e., the plate containing washed textiles with the strongest scent was set to a score of 5, and the other swatches were assigned accordingly to a score of e.g. 1˜4, based on the criteria below.
4=I think this swatch has a slightly lighter scent compared to the strongest one.
3=I know this swatch has a lighter scent compared to the strongest one.
2=This swatch has a clearly lighter scent compared to the strongest one.
1=This swatch has a much lighter scent compared to the strongest one.

The average scores of each condition were then calculated and summarized in table 4 below. It can be seen that the use of the cellulase enzyme leads to a perceivable increase in the intensity of the fragrance deposited on the textile.

TABLE 4
Averaged panel score of CN-42 cotton textile
washed with or without cellulase SEQ ID NO: 4

| | Averaged score |
|---|---|
| Without addition of cellulase | 3.5 |
| Fragrance beads with 0.05 wt % SEQ ID NO: 4 | 4.3 |
| Fragrance beads with 0.4 wt % SEQ ID NO: 4 | 4.5 |

1.-12. (canceled)

13. A method for increasing deposition of a fragrance compound to a textile, the method comprising:
(a) exposing the textile to a wash liquor comprising an enzyme having cellulase activity and one or more fragrance compounds; and
(b) optionally, rinsing the textile.

14. The method of claim 13, wherein the enzyme having cellulase activity is comprised within a cleaning composition.

15. The method of claim 14 wherein the cleaning composition is a laundry detergent composition.

16. The method of claim 13, wherein the enzyme having cellulase activity and the one or more fragrance compounds are comprised within a fragrance bead composition.

17. The method of claim 13, wherein the textile is cotton, or a mixture of cotton with other types of fabric.

18. The method of claim 17, wherein the textile is a mixture of at least 50% polyester and at least 20% cotton.

19. The method of claim 17, wherein the textile is a mixture of at least 30% polyester and at least 40% cotton.

20. The method of claim 13, wherein the enzyme having cellulase activity is selected from the group consisting of glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

21. The method of claim 13, wherein the enzyme having cellulase activity is a polypeptide having at least 60%, at least 65%, at least 70%, at least 75%, at least 80%, at least 85%, at least 90%, at least 95%, at least 96%, at least 97%, at least 98%, at least 99% or 100% sequence identity to any of the mature polypeptide of SEQ ID NO:1, SEQ ID NO:2, SEQ ID NO: 3, SEQ ID NO:4, SEQ ID NO:5 or SEQ ID NO:6.

22. A fragrance bead composition comprising an enzyme having cellulase activity and one or more fragrance compounds.

23. The fragrance bead composition of claim 22, wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

24. The fragrance bead composition of claim 22, wherein the enzyme having cellulase activity is a polypeptide having at least 60%, at least 65%, at least 70%, at least 75%, at least 80%, at least 85%, at least 90%, at least 95%, at least 96%, at least 97%, at least 98%, at least 99% or 100% sequence identity to any of the mature polypeptide of SEQ ID NO:1, SEQ ID NO: 2, SEQ ID NO:3, SEQ ID NO:4, SEQ ID NO:5 or SEQ ID NO:6.

24. A method of increasing deposition of a fragrance compound to a textile, the method comprising contacting the textile with a fragrance bead composition of claim 22.

25. A method for maintaining deposition of a fragrance compound to a textile, the method comprising contacting the textile with a fragrance bead composition comprising an enzyme having cellulase activity and one or more fragrance compounds, wherein the amount of fragrance compound in the fragrance bead composition is reduced compared to a fragrance bead composition without the enzyme having cellulase activity.

26. The method of claim 25, wherein the amount of fragrance compound in the fragrance bead composition is reduced to no more than 95%, no more than 90%, no more than 85%, no more than 80% or no more than 70%, relative to the corresponding comparable composition without the enzyme having cellulase activity.

27. The method of claim 25, wherein the enzyme having cellulase activity is selected from glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45).

28. The method of claim 25, wherein the enzyme having cellulase activity is a polypeptide having at least 60%, at least 65%, at least 70%, at least 75%, at least 80%, at least 85%, at least 90%, at least 95%, at least 96%, at least 97%, at least 98%, at least 99% or 100% sequence identity to any of the mature polypeptide of SEQ ID NO:1, SEQ ID NO:2, SEQ ID NO: 3, SEQ ID NO:4, SEQ ID NO:5 or SEQ ID NO:6.
